(19) United States
(12) Patent Application Publication
(10) Pub. No.: US 2021/0091364 A1
(43) Pub. Date: Mar. 25, 2021

(54) BATTERY MODULE

(71) Applicant: RAINUS CO., LTD., Seongnam-si (KR)

(72) Inventors: Hyun-Hak KIM, Seongnam-si (KR); Gi-Tae DO, Seongnam-si (KR); Hyun-Hun OH, Seongnam-si (KR); Min-Jae RYU, Seongnam-si (KR)

(21) Appl. No.: 17/024,442

(22) Filed: Sep. 17, 2020

(30) Foreign Application Priority Data
Sep. 19, 2019 (KR) 10-2019-0115324

(51) Int. Cl. H01M 2/30; H01M 2/26

(52) U.S. Cl. CPC H01M 2/30; H01M 2/26

(57) ABSTRACT

A battery module include a first battery having a first top electrode face and a second bottom electrode face; a second battery disposed adjacent to and flush with the first battery, wherein the second battery has a first top electrode face and a second bottom electrode face; a first support terminal being in contact with the first electrode faces of the first and second batteries and electrically connecting the first electrode faces of the first and second batteries with a first substrate terminal disposed on a substrate; and a second support terminal being in contact with the second electrode faces of the first and second batteries, and electrically connecting the second electrode faces of the first and second batteries with a second substrate terminal disposed on the substrate.

### CROSS-REFERENCE TO RELATED APPLICATIONS

This application claims the priority of Korean Patent Application No. 10-2019-0115324 filed on Sep. 19, 2019, in the Korean Intellectual Property Office, the disclosure of which is hereby incorporated by reference in its entirety.

### BACKGROUND

### 1. Field

The present disclosure relates to a battery module

### 2. Description of Related Art

When electronic components such as resistors and capacitors may be mounted on a surface of a substrate, wires inside the substrate may connect the electronic components to each other. In order that the electronic components are mounted on the substrate and operate, a battery must be connected to the substrate. The battery may be connected to the substrate via a battery module.

FIG. 1 is a view showing a battery module according to a prior art.

Referring to FIG. 1, a battery module 10 according to the prior art includes a first battery 11, a second battery 12, a first connection wing 13, a second connection wing (not shown), a first wire 14, a second wire 15, and a connection terminal 16.

The first battery 11 and the second battery 12 store power therein. When the conductor is connected thereto, the first battery 11 and the second battery 12 may discharge power therefrom via the conductor. Each of the first battery 11 and the second battery 12 includes a positive electrode and a negative electrode.

The first connection wing 13 connects the positive electrode of the first battery 11 and the positive electrode of the second battery 12 to each other. Further, the second connection wing connects the negative electrode of the first battery 11 and the negative electrode of the second battery 12 to each other.

One end of the first wire 14 and one end of the second wire 15 are connected to the first connection wing 13 and the second connection wing, respectively. The other ends of the first wire 14 and the second wire 15 are connected to the connection terminal 16. The connection terminal 16 may be connected to a substrate.

In this connection, when the connection terminal 16 is connected to the substrate, the power stored in the first battery 11 and the second battery 12 passes through the first connection wing 13 and the second connection wing and then through the first wire 14 and the second wire 15 and then through the connection terminal 16 to the substrate.

However, in the battery module 10, the wires 14 and 15 must be used instead of the conductor inside the substrate. Further, since the first wire 14 and the second wire 15 included in the battery module 10 are easily movable, the battery module 10 may not be stably mounted in a fixed manner when the battery module 10 is connected to the substrate via the connection terminal 16.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A purpose of the present disclosure is to provide a battery module that may supply power from a battery to a substrate without using a wire.

Further, a purpose of the present disclosure is to provide a battery module that may be stably mounted on a substrate in a fixed manner.

Purposes in accordance with the present disclosure are not limited to the above-mentioned purpose. Other purposes and advantages in accordance with the present disclosure as not mentioned above may be understood from following descriptions and more clearly understood from embodiments in accordance with the present disclosure. Further, it will be readily appreciated that the purposes and advantages in accordance with the present disclosure may be realized by features and combinations thereof as disclosed in the claims.

One aspect of the present disclosure provides a battery module comprising: a first battery having a columnar shape and including a first electrode face as a top face and a second electrode face as a bottom face; a second battery disposed adjacent to and flush with the first battery, wherein the second battery has a columnar shape and includes a first electrode face as a top face and a second electrode face as a bottom face; a first support terminal being in contact with the first electrode face of the first battery and the first electrode face of the second battery and electrically connecting the first electrode face of the first battery and the first electrode face of the second battery with a first substrate terminal disposed on a substrate; and a second support terminal being in contact with the second electrode face of the first battery and the second electrode face of the second battery, and electrically connecting the second electrode face of the first battery and the second electrode face of the second battery with a second substrate terminal disposed on the substrate.

In one implementation, the first support terminal includes: a first wing contacting the first electrode face of the first battery; a second wing contacting the first electrode face of the second battery; a body connected to the first wing of the first support terminal and/or the second wing of the first support terminal, and extending in a horizontal direction; and a bridge downwardly extending from a distal end of the body of the first support terminal in a vertical direction and connecting to the first substrate terminal on the substrate, wherein the second support terminal includes: a first wing contacting the second electrode face of the first battery; a second wing contacting the second electrode face of the second battery; a body connected to the first wing of the second support terminal and/or the second wing of the second support terminal, and extending in a horizontal direction; and a bridge downwardly extending from a distal end of the body of the second support terminal in a vertical direction and connecting to the second substrate terminal on the substrate.

In one implementation, the body of the first support terminal extends from a contact point between the first wing and the second wing of the first support terminal in a perpendicular manner to the first wing and the second wing of the first support terminal and in a direction such that the bridge of the first support terminal is disposed on one side of the battery module, wherein the body of the second support terminal extends from a contact point between the first wing and the second wing of the second support terminal in a perpendicular manner to the first wing and the second wing of the second support terminal, such that the bridge of the second support terminal is disposed on an opposite side of the battery module to the one side thereof.

In one implementation, the body of the first support terminal is connected to a distal end of the first wing of the first support terminal so that the bridge of the first support terminal is disposed on one side of the battery module, wherein the body of the second support terminal is connected to a distal end of the second wing of the second support terminal so that the bridge of the second support terminal is disposed on an opposite side of the battery module to the one side thereof.

In one implementation, a length of each of the first wing of the first support terminal and the first wing of the second support terminal is smaller than a diameter of the first battery, wherein a length of each of the second wing of the first support terminal and the second wing of the second support terminal is smaller than a diameter of the second battery.

In one implementation, a length of the bridge of the first support terminal is larger from a length of the bridge of the second support terminal by a vertical dimension of each of the first battery and the second battery.

In one implementation, the first battery and the second battery are fixedly disposed between and coupled to the first support terminal and the second support terminal, respectively.

Effects in accordance with the present disclosure may be as follows but may not be limited thereto.

When the battery module according to the present disclosure is used, the power may be supplied from the battery to the substrate without using an additional wire.

Further, the battery module according to the present disclosure may be stably mounted on the substrate in a fixed manner.

Moreover, the effect of the present disclosure is not limited to the above effects. It should be understood to include all possible effects derived from descriptions of the present disclosure or a configuration as set forth in the claims.

### BRIEF DESCRIPTION OF DRAWINGS

FIG. 1 is a view showing a battery module according to the prior art.

FIG. 2 is a view showing a battery module according to a first embodiment of the present disclosure as viewed from above.

FIG. 3 is a view showing the battery module according to the first embodiment of the present disclosure as viewed from below.

FIG. 4 is a view showing a manner in which a first support terminal is coupled to the battery module according to the first embodiment of the present disclosure.

FIG. 5 is a view showing a manner in which a second support terminal is coupled to the battery module according to the first embodiment of the present disclosure.

FIG. 6 is a view showing a manner in which the battery module according to the first embodiment of the present disclosure is mounted on a substrate.

FIG. 7 shows a state in which the battery module according to the first embodiment of the present disclosure is mounted on the substrate.

FIG. 8 is a view showing a battery module according to a second embodiment of the present disclosure as viewed from above.

FIG. 9 is a view showing the battery module according to the second embodiment of the present disclosure as viewed from below.

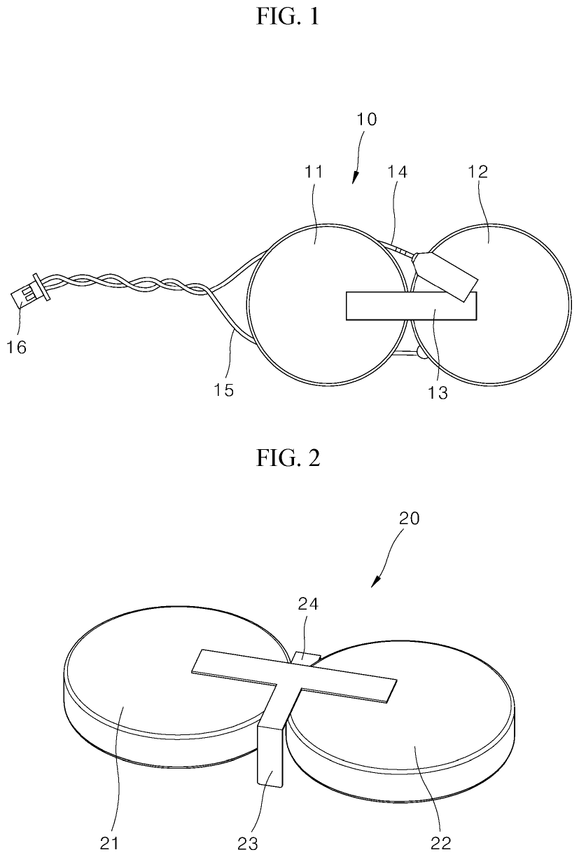

### DETAILED DESCRIPTIONS

For simplicity and clarity of illustration, elements in the figures. are not necessarily drawn to scale. The same reference numbers in different figures. denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like is disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 2 is a view showing a battery module according to a first embodiment of the present disclosure as viewed from above.

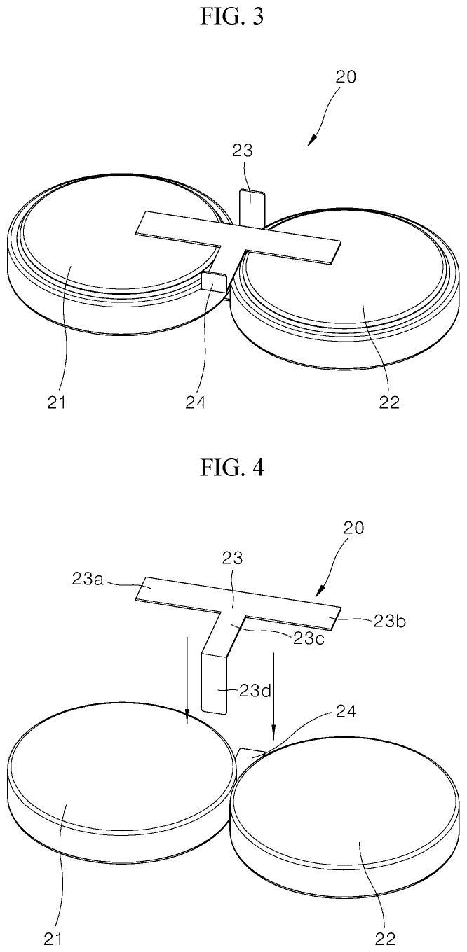

FIG. 3 is a view showing the battery module according to the first embodiment of the present disclosure as viewed from below.

Referring to FIG. 2 and FIG. 3, a battery module 20 according to the first embodiment of the present disclosure includes a first battery 21, a second battery 22, a first support terminal 23 and a second support terminal 24.

The first battery 21 includes a first electrode face and a second electrode face opposite to each other and has a column shape. The second battery 22 includes a first electrode face and a second electrode face opposite to each other and has a column shape. In this connection, the first battery 21 and the second battery 22 may have the same shape. Hereinafter, an example in which the first battery 21 and the second battery 22 have the same shape will be mainly described. However, an example in which the first battery 21 and the second battery 22 have different shapes may be applied to the present disclosure.

Each of the first electrode face and the second electrode face of each of the first battery 21 and the second battery 22 may have various shapes such as a circle, a square, and a pentagon. Hereinafter, an example in which each of the first electrode face and the second electrode face of each of the first battery 21 and the second battery 22 has a circular shape will be mainly described. However, an example in which each of the first electrode face and the second electrode face of each of the first battery 21 and the second battery 22 has a shape different from the circular shape may be applied to the present disclosure.

The first battery 21 and the second battery 22 are flush with each other. That is, the first electrode face of the first battery 21 and the first electrode face of the second battery 22 may be flush with each other, or the second electrode face of the first battery 21 and the second electrode face of the second battery 22 may be flush with each other.

The first electrode face of each of the first battery 21 and the second battery 22 may act as a positive electrode face, while the second electrode face of each of the first battery 21 and the second battery 22 may act as a negative electrode face. In contrast, the first electrode face of each of the first battery 21 and the second battery 22 may act as the negative electrode face, while the second electrode face of each of the first battery 21 and the second battery 22 may act as the positive electrode face.

The first battery 21 and the second battery 22 store power therein. When a conductor is connected thereto, the first battery 21 and the second battery 22 may discharge power therefrom via the conductor.

The first support terminal 23 contacts the first electrode face of the first battery 21 and the first electrode face of the second battery 22. Further, the first support terminal 23 electrically connects the first electrode face of the first battery 21 and the first electrode face of the second battery 22 with a first substrate terminal 31 disposed on a substrate 30. In this connection, the first support terminal 23 may be made of an electrically conductive material to electrically connect the first electrode face of the first battery 21 and the first electrode face of the second battery 22 with the first substrate terminal 31. A more detailed structure of the first support terminal 23 may be described based on FIG. 4.

FIG. 4 is a view showing a manner in which the first support terminal is coupled to the battery module according to the first embodiment of the present disclosure.

Referring to FIG. 4, the first support terminal 23 may be fixedly coupled to the first battery 21 and the second battery 22 in a direction as indicted by an arrow. The first support terminal 23 includes a first wing 23a, a second wing 23b, a body 23c and a bridge 23d.

The first wing 23a contacts the first electrode face of the first battery 21. The first wing 23a may receive power from the first electrode face of the first battery 21 and transmit the power to the body 23c.

The second wing 23b contacts the first electrode face of the second battery 22. The second wing 23b may be opposite to the first wing 23a around the body 23c. The second wing 23b may receive power from the first electrode face of the second battery 22 and transmit the same to the body 23c.

The body 23c is connected to the first wing 23a and the second wing 23b. In the battery module 20 according to the first embodiment of the present disclosure, the body 23c is connected to and is disposed between the first wing 23a and the second wing 23b. The body 23c and the first wing 23a and the second wing 23b may form a T shape. The body 23c may receive power from the first wing 23a and the second wing 23b and transmit the power to the bridge 23d.

The bridge 23d is connected to the body 23c. In this connection, the bridge 23d may have a top end connected to a distal end of the body 23c opposite to an end thereof connected to the first wing 23a and the second wing 23b. The bridge 23d has a bottom end connected to the first substrate terminal 31 on the substrate 30. Thus, the bride may extend vertically. Thus, the bridge 23d may receive power from the body 23c and supply the power to the substrate 30 via the first substrate terminal 31 on the substrate 30.

In this connection, the bridge 23d may extend vertically and the body 23c may extend horizontally. Thus, the first battery 21 and the second battery 22 may be fixedly coupled to the first support terminal 23. Thus, the battery module 20 may be stably mounted on the substrate 30.

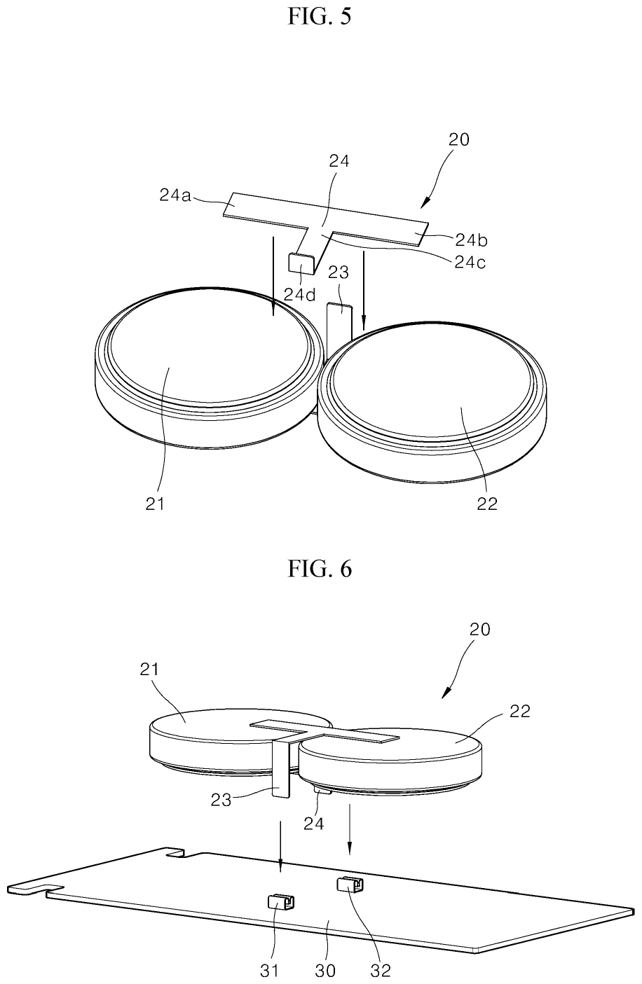

Returning to FIG. 2 and FIG. 3 again, the second support terminal 24 contacts the second electrode face of the first battery 21 and the second electrode face of the second battery 22. Further, the second support terminal 24 electrically connects the second electrode face of the first battery 21 and the second electrode face of the second battery 22 with a second substrate terminal 32 disposed on the substrate 30. In this connection, the second support terminal 24 may be made of an electrically conductive material to electrically connect the second electrode face of the first battery 21 and the second electrode face of the second battery 22 with the second substrate terminal 32. A more detailed structure of the second support terminal 24 may be described based on FIG. 5.

FIG. 5 is a view showing a manner in which the second support terminal is coupled to the battery module according to the first embodiment of the present disclosure.

Referring to FIG. 5, the second support terminal 24 may be fixedly coupled to the first battery 21 and the second battery 22 in a direction as indicated by an arrow. The second support terminal 24 includes a first wing 24a, a second wing 24b, a body 24c and a bridge 24d.

The first wing 24a contacts the second electrode face of the first battery 21. The first wing 24a may receive power from the second electrode face of the first battery 21 and transmit the same to the body 24c.

The second wing 24b contacts the second electrode face of the second battery 22. The second wing 24b may be opposite to the first wing 24a around the body 24c. The second wing 24b may receive power from the second electrode face of the second battery 22 and transmit the power to the body 24c.

The body 24c is connected to the first wing 24a and the second wing 24b to form a T shape. The body 24c, the first wing 24a and the second wing 24b may extend on the same horizontal plane. In the battery module 20 according to the first embodiment of the present disclosure, the body 24c is connected to and disposed between the first wing 24a and the second wing 24b. The body 24c may receive power from the first wing 24a and the second wing 24b and transmit the power to the bridge 24d.

The bridge 24d is connected to the body 24c. The bridge 24c may extend vertically. In this connection, the bridge 24d may have a top end connected to a distal end of the body 24c opposite to an end thereof connected to the first wing 24a and the second wing 24b. A bottom end of the bridge 24d may be connected to the second substrate terminal 32 on the substrate 30. Thus, the bridge 24d may receive power from the body 24c and supply the power to the substrate 30 via the second substrate terminal 32 on the substrate 30.

In this connection, the bridge 24d may extend vertically and the body 24c may extend horizontally. Thus, the first battery 21 and the second battery 22 may be fixedly coupled to the second support terminal 24. Thus, the battery module 20 may be stably mounted on the substrate 30.

Returning to FIG. 2 and FIG. 3 again, the bridge 23d of the first support terminal 23 may be located on one of front and rear sides of the battery module 20. That is, when the first battery 21 is a left battery and the second battery 22 is a right battery, the bridge 23d of the first support terminal 23 may be located on one of front and rear sides of the battery module 20 and at a center point of the battery module 20 between the first battery 21 and the second battery 22, as viewed from above the first electrode face. The bridge 23d extends from a top face of the battery module along a thickness of the battery module downwardly.

The bridge 24d of the second support terminal 24 may be located on the other of front and rear sides of the battery module 20. That is, when the first battery 21 is a left battery and the second battery 22 is a right battery, the bridge 24d of the second support terminal 23 may be located on the other of front and rear sides of the battery module 20 and at a center point of the battery module 20 between the first battery 21 and the second battery 22, as viewed from above the first electrode face. The bridge 24d extends from a bottom of the battery module downwardly.

The bridge 23d of the first support terminal 23 and the bridge 24d of the second support terminal 24 may be opposite to each other around the battery module, such that the battery module 20 may be mounted on the substrate 30 while the first support terminal 23 and the second support terminal 24 do not contact each other.

A length of each of the first wing 23a of the first support terminal 23 and the first wing 24a of the second support terminal 24 may be smaller than a diameter of the first battery 21. In addition, a length of each of the second wing 23b of the first support terminal 23 and the second wing 24b of the second support terminal 24 may be smaller than a diameter of the second battery 22. Thus, when the battery module 20 is placed on the substrate 30, the wings 23a, 23b, 24a, and 24b may be prevented from contacting other elements on the substrate 30.

The first battery 21 and the second battery 22 of the battery module 20 may be fixedly disposed between and coupled to the first support terminal 23 and the second support terminal 24. Thus, the first battery 21 and the second battery 22 are fixed disposed between and coupled to the first support terminal 23 and the second support terminal 24, so that the battery module 20 may be stably mounted on the substrate 30.

FIG. 6 is a view showing a manner in which the battery module according to the first embodiment of the present disclosure is mounted on the substrate.

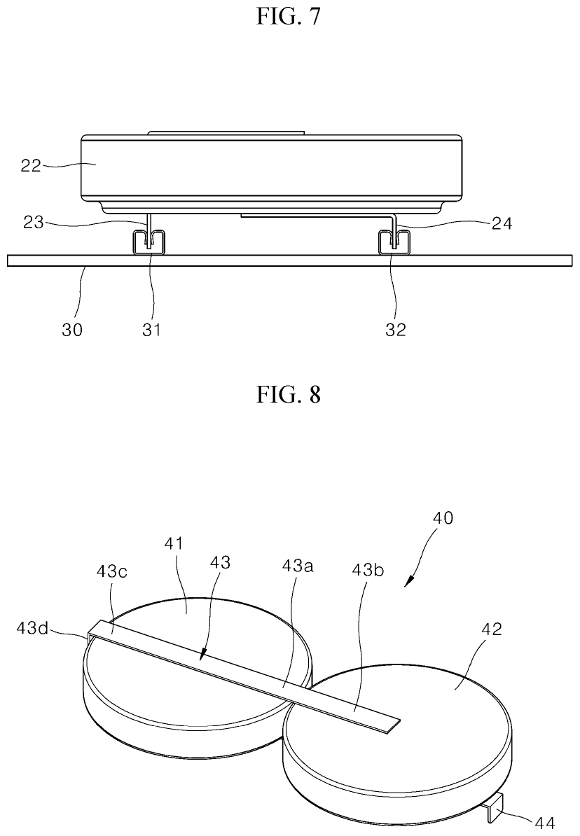

FIG. 7 shows a state in which the battery module according to the first embodiment of the present disclosure is mounted on the substrate.

Referring to FIG. 6 and FIG. 7, the battery module 20 may be mounted on the substrate 30 in a direction as indicated by an arrow.

In this connection, a length of the bridge 23d of the first support terminal 23 may be larger than a length of the bridge 24d of the second support terminal 24 by a vertical dimension of the first battery. Thus, when the battery module 20 is mounted on the substrate 30, a length by which the bridge 23d of the first support terminal 23 extends from the second electrode face of the first battery 21 or the second battery 22 to the first substrate terminal 31 on the substrate 30 is equal to a length by which the bridge 24d of the second support terminal 24 extends from the second electrode face of the first battery 21 or the second battery 22 to the second substrate terminal 32 on the substrate 30. In this way, the battery module 20 is stably mounted on the substrate 30.

The first substrate terminal 31 on the substrate 30 and the second substrate terminal 32 on the substrate 30 may be configured to receive and hold the bridge 23d of the first support terminal 23 and the bridge 24d of the second support terminal 24, respectively. In this connection, the first substrate terminal 31 on the substrate 30 and the second substrate terminal 32 on the substrate 30 may have elasticity.

Thus, when the first substrate terminal 31 on the substrate 30 and the second substrate terminal 32 on the substrate 30 have elasticity, and the first substrate terminal 31 on the substrate 30 and the second substrate terminal 32 on the substrate 30 receive and hold the bridge 23d of the first support terminal 23 and the bridge 24d of the second support terminal 24, respectively, the battery module 20 mounted on the substrate 30 may be prevented from being removed from the substrate 30 when external shaking force occurs.

The bridge 23d of the first support terminal 23 and the bridge 24d of the second support terminal 24 may be thin so as to be inserted into the first substrate terminal 31 on the substrate 30 and the second substrate terminal 32 on the substrate 30.

FIG. 8 is a view showing a battery module according to a second embodiment of the present disclosure as viewed from above.

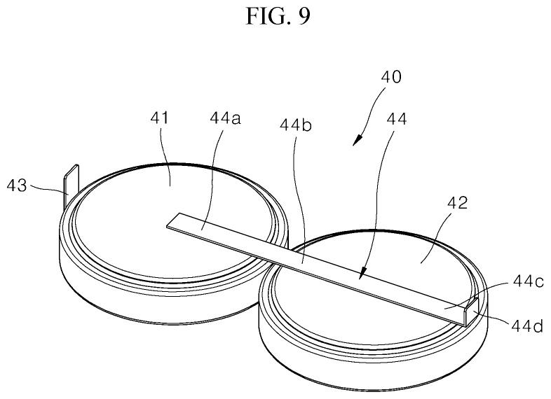

FIG. 9 is a view showing the battery module according to the second embodiment of the present disclosure as viewed from below.

Referring to FIG. 8 and FIG. 9, a battery module 40 according to the second embodiment of the present disclosure includes a first battery 41, a second battery 42, a first support terminal 43 and a second support terminal 44.

In this connection, the first battery 41 and the second battery 42 of the battery module 40 according to the second embodiment of the present disclosure are the same as the first battery 21 and the second battery 22 of the battery module 20 according to the first embodiment of the present disclosure. Thus, the description thereof will be omitted.

Further, the first support terminal 43 and the second support terminal 44 of the battery module 40 according to the second embodiment of the present disclosure are similar to the first support terminal 23 and the second support terminal 24 of the battery module 20 according to the first embodiment of the present disclosure. In this regard, following descriptions will focus on differences therebetween.

The first support terminal 43 includes a first wing 43a, a second wing 43b, a body 43c and a bridge 43d. The second support terminal 44 includes a first wing 44a, a second wing 44b, a body 44c and a bridge 4d.

The body 43c of the first support terminal 43 is connected to a distal end of the first wing 43a. The body 44c of the second support terminal 44 is connected to a distal end of the second wing 44b.

A sum of lengths of the first wing 43a of the first support terminal 43 and the body 43c of the first support terminal 43 may be equal to a diameter of the first battery 41. A length of the second wing 43b of the first support terminal 43 may be smaller than a diameter of the second battery 42. A length of the first wing 44a of the second support terminal 44 may be smaller than the diameter of the first battery 41. A sum of lengths of the second wing 44b of the second support terminal 44 and the body 44c of the second support terminal 44 may be equal to the diameter of the second battery 42. Thus, when the battery module 40 is placed on the substrate 30, the wings 43a, 43b, 44a, and 44b and the bodies 43c and 44c may be prevented from contacting other elements on the substrate 30.

In this connection, the bridge 43d of the first support terminal 43 may be located on one of left and right sides of the battery module 40. That is, when the first battery 41 is the left battery and the second battery 42 is the right battery, the bridge 43d of the first support terminal 43 may be located on a left side of the battery module 40, that is, the left side of the first battery 41 and at a left distal end of the battery module, as viewed from above of the first electrode face.

Further, the bridge 44d of the second support terminal 44 may be located on the other of left and right sides of the battery module 40. That is, when the first battery 41 is the left battery and the second battery 42 is the right battery, the bridge 43d of the first support terminal 43 may be located on a right side of the battery module 40, that is, the right side of the first battery 41 and at a right distal end of the battery module, as viewed from above of the first electrode face.

Thus, unlike the battery module 20 according to the first embodiment of the present disclosure, in this embodiment, a spacing between the bridge 43d of the first support terminal 43 and the bridge 44d of the second support terminal 44 may increase. Thus, when a spacing between the first substrate terminal 31 and the second substrate terminal 32 on the substrate 30 is large, the battery module 40 according to the second embodiment of the present disclosure may be used.

When the battery module according to the present disclosure is used, the power may be supplied from the battery to the substrate without using an additional wire. Further, the battery module according to the present disclosure may be stably mounted on the substrate in a fixed manner. Moreover, the effect of the present disclosure is not limited to the above effects. It should be understood to include all possible effects derived from descriptions of the present disclosure or a configuration as set forth in the claims.

The present disclosure as described above may be subjected to various substitutions, modifications, and changes within the scope of the present disclosure without departing from the technical spirit of the present disclosure by a person having ordinary knowledge in the technical field to which the present disclosure belongs. Thus, the disclosure is not limited to the accompanying drawings.

What is claimed is:

1. A battery module comprising:
a first battery having a columnar shape and including a first electrode face as a top face and a second electrode face as a bottom face;
a second battery disposed adjacent to and flush with the first battery, wherein the second battery has a columnar shape and includes a first electrode face as a top face and a second electrode face as a bottom face;
a first support terminal being in contact with the first electrode face of the first battery and the first electrode face of the second battery and electrically connecting the first electrode face of the first battery and the first electrode face of the second battery with a first substrate terminal disposed on a substrate; and
a second support terminal being in contact with the second electrode face of the first battery and the second electrode face of the second battery, and electrically connecting the second electrode face of the first battery and the second electrode face of the second battery with a second substrate terminal disposed on the substrate.

2. The battery module of claim 1, wherein the first support terminal includes:
a first wing contacting the first electrode face of the first battery;
a second wing contacting the first electrode face of the second battery;
a body connected to the first wing of the first support terminal and/or the second wing of the first support terminal, and extending in a horizontal direction; and
a bridge downwardly extending from a distal end of the body of the first support terminal in a vertical direction and connecting to the first substrate terminal on the substrate,
wherein the second support terminal includes:
a first wing contacting the second electrode face of the first battery;
a second wing contacting the second electrode face of the second battery;
a body connected to the first wing of the second support terminal and/or the second wing of the second support terminal, and extending in a horizontal direction; and
a bridge downwardly extending from a distal end of the body of the second support terminal in a vertical direction and connecting to the second substrate terminal on the substrate.

3. The battery module of claim 2, wherein the body of the first support terminal extends from a contact point between the first wing and the second wing of the first support terminal in a perpendicular manner to the first wing and the second wing of the first support terminal and in a direction such that the bridge of the first support terminal is disposed on one side of the battery module,
wherein the body of the second support terminal extends from a contact point between the first wing and the second wing of the second support terminal in a perpendicular manner to the first wing and the second wing of the second support terminal, such that the bridge of the second support terminal is disposed on an opposite side of the battery module to the one side thereof.

4. The battery module of claim 2, wherein the body of the first support terminal is connected to a distal end of the first wing of the first support terminal so that the bridge of the first support terminal is disposed on one side of the battery module,
wherein the body of the second support terminal is connected to a distal end of the second wing of the second support terminal so that the bridge of the second support terminal is disposed on an opposite side of the battery module to the one side thereof.

5. The battery module of claim 2, wherein a length of each of the first wing of the first support terminal and the first wing of the second support terminal is smaller than a diameter of the first battery,
wherein a length of each of the second wing of the first support terminal and the second wing of the second support terminal is smaller than a diameter of the second battery.

6. The battery module of claim 2, wherein a length of the bridge of the first support terminal is larger from a length of the bridge of the second support terminal by a vertical dimension of each of the first battery and the second battery.

7. The battery module of claim 1, wherein the first battery and the second battery are fixedly disposed between and coupled to the first support terminal and the second support terminal, respectively.
